(19) United States
(12) Patent Application Publication
(10) Pub. No.: US 2026/0369249 A1
(43) Pub. Date: Nov. 19, 2026

(54) QUALITY CONSTRAINED METHOD AND DEVICE FOR ENERGY REDUCTION CONTROL OF VISUAL CONTENT USING ALTERNATING COMPLEMENTARY COLORS

(71) Applicant: InterDigital CE Patent Holdings, SAS, Paris (FR)

(72) Inventors: Claire-Helene DEMARTY, MONTREUIL LE GAST (FR); Kilian RAVON, RENNES (FR); Laurent BLONDE, THORIGNE-FOUILLARD (FR); Franck AUMONT, VERN SUR SEICHE (FR)

(21) Appl. No.: 19/487,906

(22) PCT Filed: May 23, 2024
(86) PCT No.: PCT/EP2024/064237

§ 371 Date: Nov. 25, 2025

(30) Foreign Application Priority Data
Jun. 1, 2023 (EP) 23305865.0

(51) Int. Cl. G09G 5/02

(52) U.S. Cl. CPC G09G 5/026; G09G 2300/0452; G09G 2340/06

(57) ABSTRACT

A method introduces, for visual contents using spatially alternating complementary colors or temporally alternating complementary colors processing algorithms, the notion of a quality/energy optimization for these algorithms. This optimization is performed under control of at least one energy reduction criterion and at least one quality of experience criterion, or a criterion combining energy reduction and quality of experience. It allows to provide increased energy reduction compared to the alternating complementary colors techniques, at the cost of an acceptable decrease in terms of quality of experience.

### CROSS-REFERENCE TO RELATED APPLICATIONS

This application claims the priority to European Application No 23305865.0 filed 1^{st} of June 2023, which is incorporated herein by reference in its entirety.

### TECHNICAL FIELD

The disclosure is in the field of multimedia content distribution, and at least one embodiment relates more specifically to optimize power and quality criteria for energy consumption reduction when using spatially alternating complementary colors or temporally alternating complementary colors energy reduction processing algorithms in systems handling a visual content such as an image or video.

### BACKGROUND ART

Reducing energy consumption of electronic devices has become a requirement not only for manufacturers of electronic devices but also to limit, as much as possible, the environmental impact and to contribute to the emergence of a sustainable display industry. The increase in display resolution from SD to HD, then to 4K and soon to 8K and beyond, as well as the introduction of high dynamic range imaging, has brought about a corresponding increase in energy requirements of display devices. This is not consistent with the global need to reduce energy consumption knowing that a huge number of devices has a display (i.e., TV, Mobile phones, tablets, etc.). Indeed, displays are the most important source of energy consumption, for consumer electronic devices, either battery-powered (e.g., smartphones, tablets, head-mounted displays, car display screens) or not (e.g., television sets, advertisement display panels).

Different display technologies have been developed in the recent years. Although modern displays consume energy in a more controllable and efficient manner than older displays, they remain the most important source of energy consumption in a video chain.

As far as backlight displays are concerned, their energy consumption is largely determined by the intensity of the backlight.

Organic Light Emitting Diode (OLED) is one example of display technology that is finding increasingly widespread use because of numerous advantages compared to former technologies such as Thin-Film Transistor Liquid Crystal Displays (TFT-LCDs). Rather than using a uniform backlight, OLED displays, as well as mini LEDS, are composed of individual directly emissive image pixels. OLEDs power consumption is therefore highly correlated to the image content and the power consumption for a given input image can be estimated by considering the values of the displayed image pixels.

It is therefore interesting to elaborate energy-aware images or videos, i.e., images or videos that will need less energy when displayed, notably on consumer electronics OLED displays. Techniques to reduce the energy consumption comprise, for example, spatially alternating complementary colors (SACC) or temporally alternating complementary colors (TACC) that exploit the principles of alternating complementary colors, as further described below. These techniques aim at reducing the energy requirements of display devices with the goal of preserving the quality of experience (QoE) based on contrast, luminance, temporal smoothness, or color levels for instance.

### SUMMARY

With the current energy awareness context and the fight against climate change, facing the need to reduce energy footprint in the consumer electronics domain, SACC and TACC image processing algorithms have been developed with the common objective of minimizing the energy consumed by displays when using (for example displaying) video images and maximizing the quality of experience for the user.

Embodiments described hereafter have been designed with the foregoing in mind and introduce, for visual contents using spatially alternating complementary colors or temporally alternating complementary colors processing algorithms, the notion of a quality/energy optimization for these algorithms. This optimization is performed under control of at least one energy reduction criterion and at least one quality of experience criterion, or a criterion combining energy reduction and quality of experience. It allows to provide increased energy reduction compared to the alternating complementary colors techniques, at the cost of an acceptable decrease in terms of quality of experience.

A first aspect is directed to a method comprising, for an input color in an image, determining a pair of symmetrical colors with regard to input color in a lab color space, based on at least one quality criterion and at least one power reduction criterion or based on a criterion combining quality and power reduction, wherein an average color of the pair of spatially or temporally alternating complementary colors is perceptually identical to the input color and a sum of the energies consumed by displaying the colors of the pair of spatially or temporally alternating complementary colors is lower than twice the energy consumed by displaying the input color. A variant of the first aspect further comprises selecting a color value for a first color of the pair of spatially alternating complementary colors and determining a second color of the pair of spatially alternating complementary colors based on the selected first color value and on the input color, the first color being selected based on a maximal color distance relative to the input color or being a saturated color or being a greyscale color or having the same luminance than the input color. A variant of the first aspect further comprises iterating the method for a plurality of input colors comprising all possible color values of the lab color space or a subset of all possible color values of the lab color space and storing an association between an input color and the selected pair of colors of the set of candidate pairs for the input color in a correspondence table using an input color as index.

A second aspect is directed to a method comprising, obtaining a visual content, iterating over pixels of the visual content and, for each pixel, obtaining a pixel color, determining a pair of colors according to the first aspect, replacing the pixel by a pair of spatially or temporally half-pixels, the first half-pixel being assigned the first color of the pair and the second half-pixel being assigned the second color of the pair, and providing the modified visual content.

A third aspect is directed to an apparatus comprising a processor configured to carry out the method according to the first aspect.

A fourth aspect is directed to a computer program including instructions, which, when executed by a computer, cause the computer to carry out the method according to the first aspect.

A fifth aspect is directed to a non-transitory computer readable medium storing executable program instructions to cause a computer executing the instructions to perform a method according to the first aspect.

The above presents a simplified summary of the subject matter to provide a basic understanding of some aspects of the present disclosure. This summary is not an extensive overview of the subject matter. It is not intended to identify key/critical elements of the embodiments or to delineate the scope of the subject matter. Its sole purpose is to present some concepts of the subject matter in a simplified form as a prelude to the more detailed description provided below.

### BRIEF SUMMARY OF THE DRAWINGS

The present disclosure may be better understood by consideration of the detailed description below in conjunction with the accompanying figures in which:

FIG. 1 illustrates a block diagram of an example of display device in which various aspects and embodiments are implemented.

FIG. 2 illustrates the normalized response spectra of human retina cones (or spectral sensitivity functions).

FIG. 3A illustrates examples of transformation of colors into complementary colors according to the technique of spatially alternating complementary colors.

FIG. 3B illustrates examples of replacement of a pixel by a pair of pixels according to the technique of spatially alternating complementary colors.

FIG. 4A illustrates the temporal contrast sensitivity function for various adapting fields.

FIG. 4B illustrates the modulation sensitivity as a function of frequency for luminance and chromatic flicker.

FIG. 5A illustrates examples of transformation of colors into complementary colors according to the technique of temporally alternating complementary colors.

FIG. 5B illustrates examples of replacement of a pixel by a pair of pixels according to the technique of temporally alternating complementary colors.

FIG. 6 illustrates the notion of indistinguishable colors represented by MacAdam ellipses for one of MacAdam's test participant.

FIG. 7A illustrates the power reduction gain for a pair of colors selected according to the SACC or TACC techniques.

FIG. 7B illustrates the areas of the color space with gains and losses for a pair of colors selected according to the SACC or TACC techniques.

FIG. 7C illustrates the flicker acceptability for a pair of colors selected according to the TACC technique.

FIG. 8 illustrates an example of a process for establishing the pair candidates of alternating complementary colors according to embodiments.

FIG. 9 illustrates an example of a process for reducing the energy consumption for a pixel of an image using alternating complementary colors according to embodiments.

FIG. 10 illustrates an example of a process for generating a correspondence table for alternating complementary colors according to embodiments.

FIG. 11 illustrates two examples of deployment for the alternating complementary color process according to embodiments.

It should be understood that the drawings are for purposes of illustrating examples of various aspects, features, and embodiments in accordance with the present disclosure and are not necessarily the only possible configurations. Throughout the various figures, like reference designators refer to the same or similar features.

### DETAILED DESCRIPTION

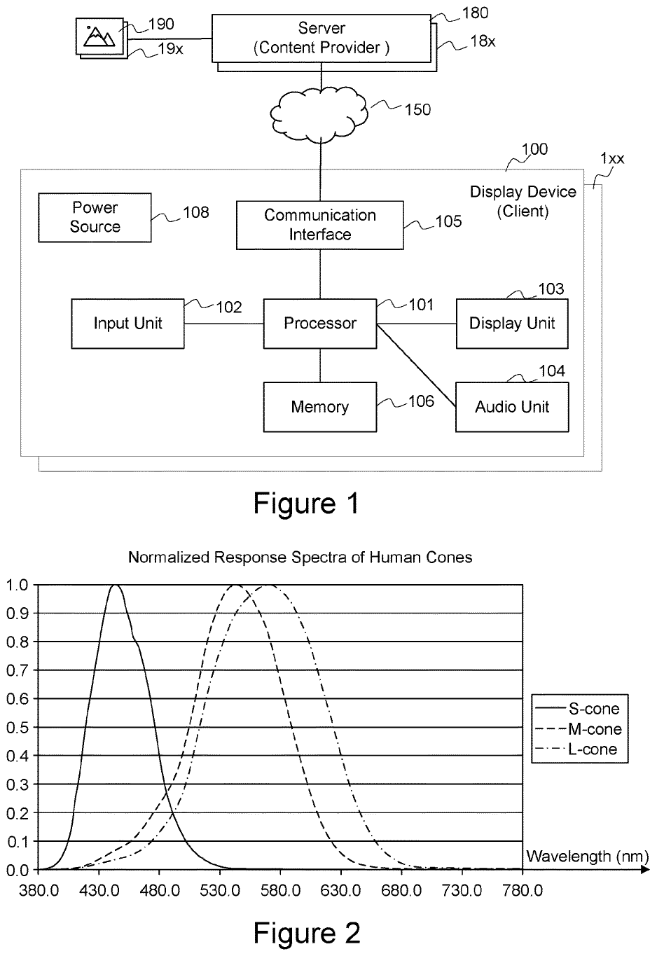

FIG. 1 illustrates a block diagram of an example of display device in which various aspects and embodiments are implemented. In the depicted environment, a user interacts with the display device 100, for example a television, that is connected to a server 180 for example operated by a content provider. The server 180 delivers multimedia content 190 such as video streams based on images. In a video distribution system, multiple devices 100, 1xx are interacting with multiple content providers and corresponding servers 180, 18x delivering multiple multimedia content 190, 19x. A single content provider may use a plurality of servers. The devices exchange data through a communication network 150.

The communication network 150 preferably uses a communication standard to provide interoperability between content provider and display devices. Such communication standard may be wireless, such as cellular (e.g., LTE) communications, Wi-Fi communications, and the like, to ensure the mobility of the display device. Cable, satellite or terrestrial digital television broadcast communication may also be used for the communication network 150 as well as broadband television communications. Such digital television standards may on based on well-established standards like DVB, ATSC, or the like. General purpose network standards may also be used, for example based on Ethernet.

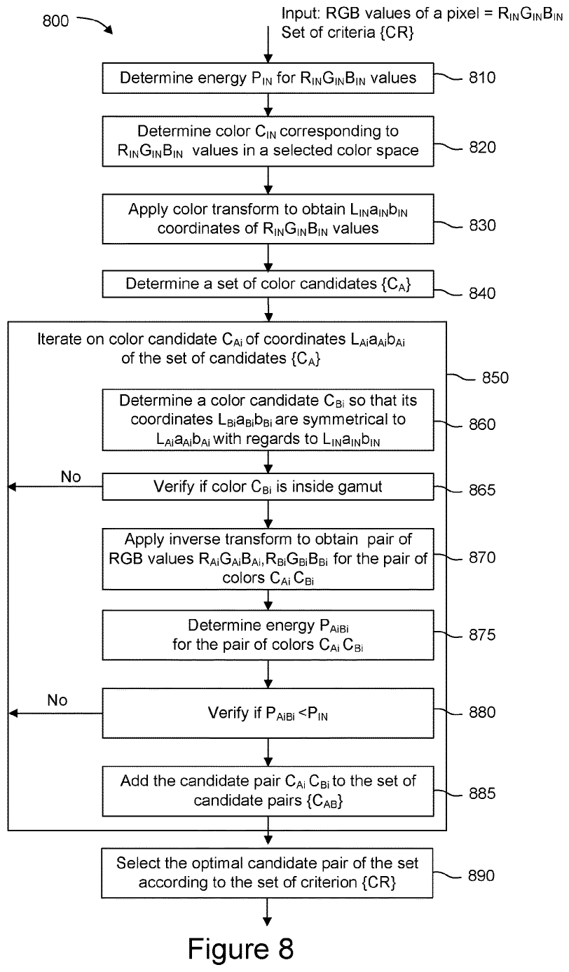

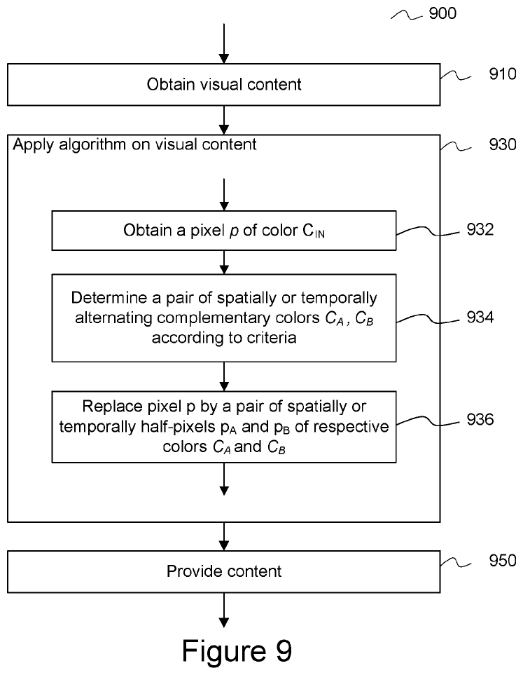

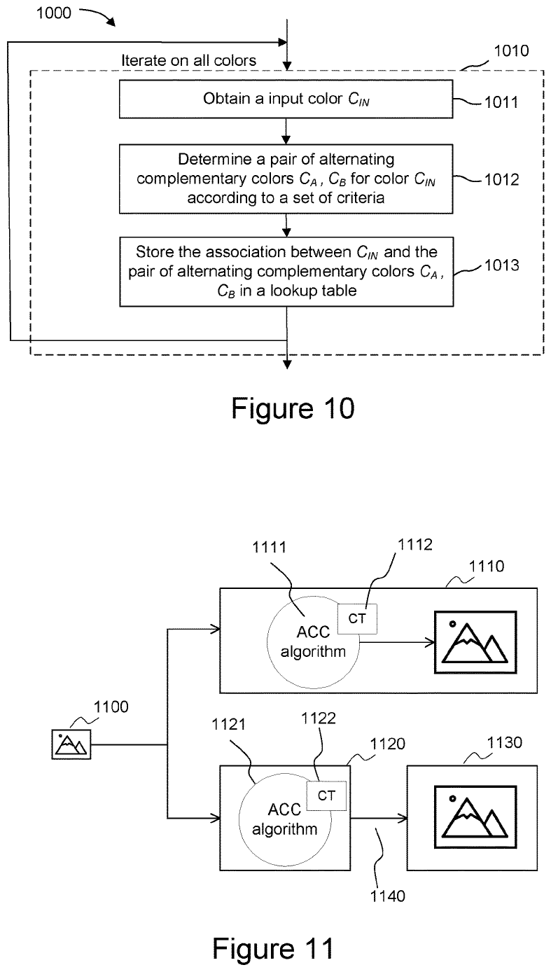

The display device 100 comprises a processor 101. The processor 101 may be a general-purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor may perform data processing such as the process 800 of FIG. 8 or the process 900 of FIG. 9 or the process 1000 of FIG. 10.

The processor 101 may be coupled to an input unit 102 configured to convey user interactions. Multiple types of inputs and modalities can be used for that purpose. Physical keypad or a touch sensitive surface are typical examples of input adapted to this usage although voice control could also be used. In addition, the input unit may also comprise a digital camera able to capture still pictures or video in two dimensions or a more complex sensor able to determine the depth information in addition to the picture or video and thus able to capture a complete 3D representation.

The processor 101 may be coupled to a display unit 103 configured to output visual data to be displayed on a screen. Multiple types of displays can be used for that purpose such as a liquid crystal display (LCD) or organic light-emitting diode (OLED) display unit. The processor 101 may also be coupled to an audio unit 104 configured to render sound data to be converted into audio waves through an adapted transducer such as a loudspeaker for example.

The processor 101 may be coupled to a communication interface 105 configured to exchange data with external devices. The communication preferably uses a wireless communication standard to provide mobility of the display device, such as cellular (e.g., LTE) communications, Wi-Fi communications, and the like.

The processor 101 may access information from, and store data in, the memory 106, that may comprise multiple types of memory including random access memory (RAM), read-only memory (ROM), a hard disk, a subscriber identity module (SIM) card, a memory stick, a secure digital (SD) memory card, any other type of memory storage device. In embodiments, the processor 101 may access information from, and store data in, memory that is not physically located on the device, such as on a server, a home computer, or another device.

The processor 101 is configured to execute an image energy reduction algorithm that modifies an input image into an image that requires less energy when being used, for example displayed, in comparison to using the input image. Different techniques have been disclosed to provide such feature.

The processor 101 may receive power from the power source 108 and may be configured to distribute and/or control the power to the other components in the device 100. The power source may be any suitable device for powering the device. As examples, the power source may include one or more dry cell batteries (e.g., nickel-cadmium (NiCd), nickel-zinc (NiZn), nickel metal hydride (NiMH), lithium-ion (Li-ion), and the like), solar cells, fuel cells, and the like.

While the figure depicts the processor 101 and the other elements 102 to 108 as separate components, it will be appreciated that these elements may be integrated together in an electronic package or chip. It will be appreciated that the display device 100 may include any sub-combination of the elements described herein while remaining consistent with the embodiments described hereafter. The processor 101 may further be coupled to other peripherals or units not depicted in FIG. 1 which may include one or more software and/or hardware modules that provide additional features, functionality and/or wired or wireless connectivity. For example, the peripherals may include a universal serial bus (USB) port, a vibration device, a television transceiver, a hands-free headset, a Bluetooth® module, a frequency modulated (FM) radio unit, a digital music player, a media player, a video game player module, an Internet browser, and the like. For example, the processor 101 may be coupled to a localization unit configured to localize the display device within its environment. The localization unit may integrate a GPS chipset providing longitude and latitude position regarding the current location of the display device but also other motion sensors such as an accelerometer and/or an e-compass that provide localization services.

In at least one embodiment, the processor 101 of the display device 100 is configured to display on the display unit 103 an image according to embodiments described further below. In a first variant embodiment, the image 190 is obtained from the content provider server 180 through the communication network 150. In a second variant embodiment, the image is obtained from the memory 106, stored for example after being captured by the input unit 102 or being transferred from a server. Such embodiment is illustrated by device 1110 of FIG. 11.

Typical examples of device 100 are smartphones, tablets, laptops, monitors, head-mounted displays, television sets, video projectors, computer screens, vehicles (e.g., control and/or entertainment systems for cars, planes, boats, etc.), advertisement display panels, medical monitors, etc. However, any device or composition of devices that provides similar functionalities can be used as display device 100 while still conforming with the principles of the disclosure.

In at least one embodiment, the device does not include a display unit but prepares data representative of an energy-reduced visual content so that another device can utilize the energy-reduced visual content for further processing. In at least one embodiment, such device prepares data to be displayed by another device such as a screen. Examples of such devices are set top boxes, media players, desktop computers, encoders, decoders, servers, computing grids, cloud computers, etc. Such embodiment is illustrated by device 1120 of FIG. 11.

At least one example of an embodiment can involve a device including an apparatus as described herein and at least one of (i) an antenna configured to receive a signal, the signal including data representative of the image information, (ii) a band limiter configured to limit the received signal to a band of frequencies that includes the data representative of the image information, and (iii) a display configured to display an image from the image information. At least one example of an embodiment can involve a device as described herein, wherein the device comprises one of a television, a television signal receiver, a set-top box, a gateway device, a mobile device, a cell phone, a tablet, a computer, a laptop, or other electronic device.

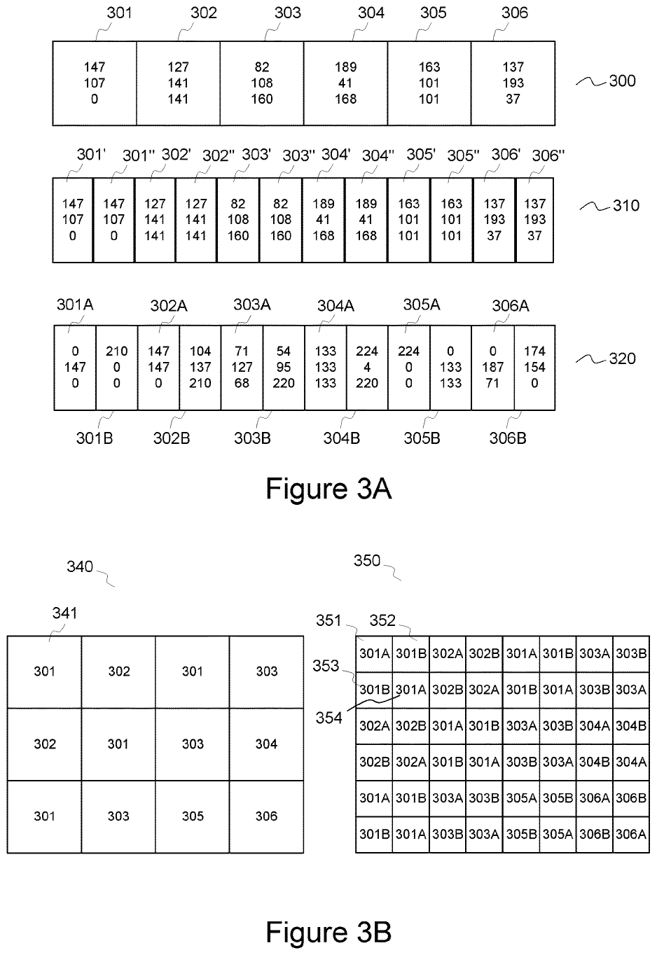

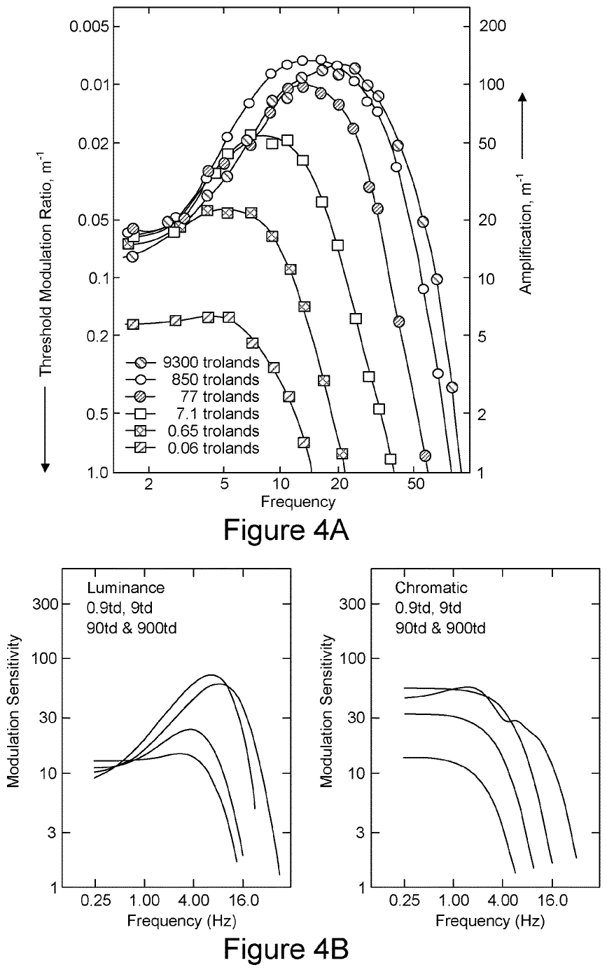

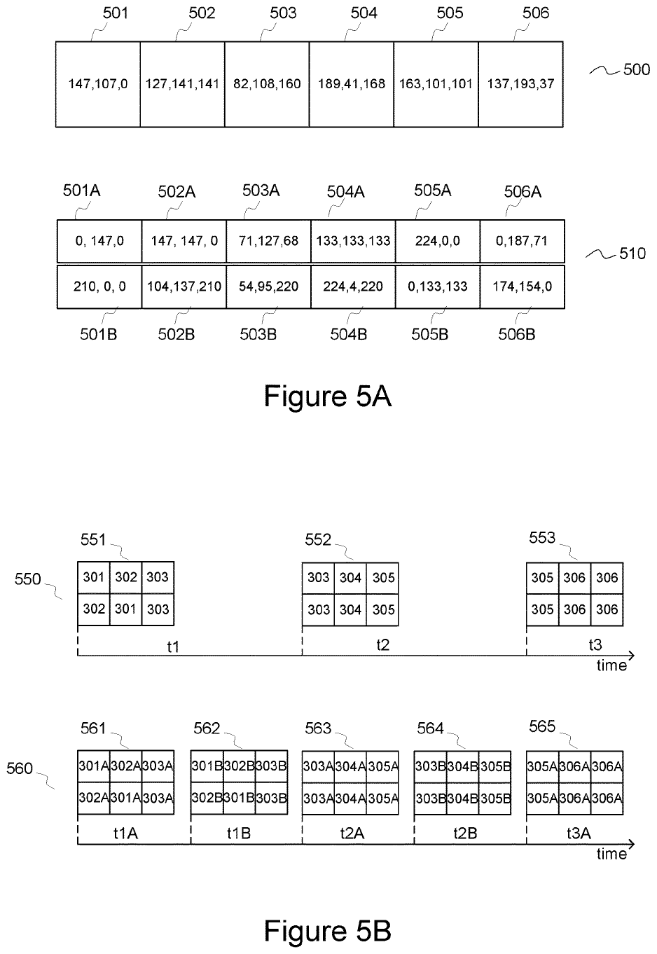

Two techniques allow to minimize the energy consumption when displaying (or more generally when using) an image. These techniques are based on using alternating complementary colors to modify an image so that it requires less energy. The first technique modifies the image through a spatial alternating arrangement (FIGS. 2, 3A, 3B) and the second uses a temporal alternating arrangement (FIGS. 4A, 4B, 5A, 5B).

FIG. 2 illustrates the normalized response spectra of human retina cones (or spectral sensitivity functions). Electromagnetic radiation is characterized by its wavelength (or frequency) and its intensity. The range of wavelengths humans can perceive is approximately from 380 nm to 780 nm. When the wavelength is within this range, it is known as “visible light”. Perception of color is based upon the varying sensitivity of different cells in the retina (color receptors: cones and rods) to light of different wavelengths. Human observers have three types of color receptors, known as cone cells. This confers trichromatic color vision, cones being usually labeled either according to the wavelengths of the peaks of their spectral sensitivities: short (S), medium (M), and long (L), or simply according to the primary colors those peaks are centered on: Blue, Green, or Red as illustrated in FIG. 2.

Trichromatic theory teaches us that the color a human observer perceives of a light spectrum can be characterized by 3 single scalar values. From a mathematical point a view, this initial step of human vision could be compared to that of a triple-kernel energy computation process. Let si(λ) be the wavelength response of a given light spectrum, and l(λ), m(λ), and s(λ) be respectively the spectral sensitivity functions of the L, M, and S cones, equation 1 below defines Li, Mi, and Si. These are the 3 scalar values that characterize the color of spectrum si(λ) seen by a human observer.

$${L}_{i} = {{\int }_{- ∞}}^{+ ∞} {s}_{i} ( λ ) . l ( λ ) d λ \\ {M}_{i} = {{\int }_{- ∞}}^{+ ∞} {s}_{i} ( λ ) . m ( λ ) d λ \\ {S}_{i} = {{\int }_{- ∞}}^{+ ∞} {s}_{i} ( λ ) . s ( λ ) d λ \qquad ( 1 )$$

Although the spectrum of light reaching the eye from a given direction determines the color sensation in that direction, there are many more possible spectral combinations that result in the same color sensations. In colorimetry, the term metamerism refers to the matching of a same apparent color of light signals with different spectral power distributions. Color spectra that match this way are called metameric spectra. Based on Equation (1), the mathematical definition of metamerism would be ∀λ∈R:

$$∃ λ ∈ [ 380 , 780 ] . {s}_{i} ( λ ) \neq {s}_{2} ( λ ) \qquad ( 2 a )$$

$${{\int }_{- ∞}}^{+ ∞} {s}_{1} ( λ ) . l ( λ ) d λ = {{\int }_{- ∞}}^{+ ∞} {s}_{2} ( λ ) . l ( λ ) d λ \qquad ( 2 b )$$

$${{\int }_{- ∞}}^{+ ∞} {s}_{1} ( λ ) . m ( λ ) d λ = {{\int }_{- ∞}}^{+ ∞} {s}_{2} ( λ ) . m ( λ ) d λ \qquad ( 2 c )$$

$${{\int }_{- ∞}}^{+ ∞} {s}_{1} ( λ ) . s ( λ ) d λ = {{\int }_{- ∞}}^{+ ∞} {s}_{2} ( λ ) . s ( λ ) d λ \qquad ( 2 d )$$

where s1(λ) and s2(λ) are the spectral compositions of two metameric (yet different) spectra.

The term spatial resolution refers to the distance between independent measurements, or the physical dimension that represents a pixel of an image. It is thus the distance between two adjacent pixels of a displayed image. Visual acuity of human eye limits the spatial resolution that the visual system can process. According to various studies performed, human visual system can discern spatial differences of ~0.6 arcminutes. As 1′×π/(60×180)=0.0002909 rad, 0.6 arcminutes=0.0001745328 rad. Above a given viewing distance, two adjacent pixels cannot be resolved, they are perceived as a single pixel. The luminous power from the various subpixels is summed up and this gives the apparent continuity of images as seen on a screen. This is the notion of spatial fusion. Embodiments described herein are designed to benefit from the visual fusion of the human visual system and more particularly, the unification of visual excitations from the corresponding retinal images of adjacent pixels into a single visual percept. For example, the usual viewing distance for a mobile phone screen is 25-30 cm. So, if the distance between two-point size light sources is less than 0.044-0.052 mm, they will appear as single source. For a TV screen watched from a 3 meters distance, if the distance between two-point size light sources is less than 0.52 mm, they will typically appear as single source.

At least one technique uses these principles to determine a pair of colors that, when being spatially combined, is perceived by a human observer as another (single and stable) color. Indeed, the technical effect used herein relies on the visual fusion characteristic of the human vision system. In other words, when visualizing a display of spatially alternating complementary colors, the human visual system perceives a single and stable corresponding color that visually has the same perceptual characteristics.

Therefore, the high-level principle of a first technique to minimize the energy consumption can be considered as adding a dimension to the image signal by replacing a color by two visually complementary colors, the two colors being arranged spatially. The two adjacent pixels of spatially alternating complementary colors would be perceived by the user as a single pixel with maximal visual similarity. This principle is herein named spatially alternating complementary colors (SACC).

A first technique to reduce the energy needed to display the modified pixels on a display device is based on modifying a pair of color pixels using SACC while preserving as much as possible the visual similarity with the original pair of pixels and quality of experience. Such methods exploit the principle of visual and spatial fusion and propose to set the colors of a pair of adjacent pixels of the image to a pair of spatially alternating complementary colors requiring less energy for display. A pair of spatially alternating complementary colors is selected so that the average color of the pair of colors is perceptually identical to an input color or an average of input colors and the energy of the pair of colors is lower than the energy of the input color. The term “energy of the color” should be understood here as the energy needed for rendering a pixel of the color. Different types of spatial replacement are described: pixel doubling, pixel skipping and pixel averaging.

A first method for SACC is based on pixel doubling (it may also be understood as pixel splitting). In other words, the number of pixels of an input image is doubled to create a couple of adjacent pixels, either in width only or in height only or in both dimensions, thus adding new “duplicated” pixels forming the second half of the pair of adjacent pixels. A pixel of the original image is replaced by two pixels of same color (thus the notion of splitting). The pair of adjacent pixels (an original pixel and a duplicated pixel) is then replaced by a pair of pixels of spatially alternating complementary colors, in other words, the pair of spatially alternating complementary colors are assigned to the adjacent pixels. In the case where the original content sent to a display is of a lower resolution than the resolution of the display, an internal upsampling is usually undergone inside the display itself. In such case, this upsampling may be replaced by this first method based on pixel doubling which implicitly uses an upsampled resolution.

A second method for SACC is based on pixel skipping where one pixel over two is set free by cancelling the content initially displayed on it, and the pair of spatially alternating complementary colors is determined based on the color of the first pixel of each adjacent pair of pixels of the original image only, thus no more taking into account the color of the second pixel of the original pair. This allows to set the colors of an original pair of adjacent pixels by a pair of spatially alternating complementary colors: the first pixel of the original pair being assigned the first color of the pair of spatially alternating complementary colors, and the second pixel of the original pair being assigned the second color of the pair of spatially alternating complementary colors.

A third method for SACC is based on pixel averaging where the pair of spatially alternating complementary colors is determined based on an average color computed from the colors of the first and second pixels of a couple of adjacent pair of pixels of the original image. The first pixel of the original adjacent pair is assigned the first color of the pair of spatially alternating complementary colors and the second pixel of the original adjacent pair is assigned the second color of the pair of spatially alternating complementary colors. Unlike the second method based on pixel skipping, this third method takes into account the colors of all the pixels of the original image or video.

For all three methods, different arrangements of adjacent pixels can be used, for example based on stripe patterns, mosaic patterns or random patterns.

The notion of adjacent pixel is introduced above to facilitate the understanding. However, the three SACC methods described above share the same principle of replacing an input pixel of an input color by a couple of pixels of spatially alternating complementary colors.

FIG. 3A illustrates examples of transformation of colors into complementary colors according to the technique of spatially alternating complementary colors. In this figure, the line 300 corresponds to an extract of an original image and represents a line of pixels 301 to 306. The three numbers inside each block correspond to the color of the corresponding pixel, represented by RGB values expressed using an 8-bit depth. For example, the first pixel 301 is defined by the following values for the color components of the pixel: 147 for red, 107 for green and 0 for blue. This results in a brown pixel. The colors of the other pixels are respectively medium grey for second pixel 302, navy blue for the third pixel 303, dark magenta for the fourth pixel 304, reddish brown for the fifth pixel 305, and bright green for the sixth pixel 306.

The figure illustrates a method based on pixel doubling in horizontal direction. For that, it is necessary to duplicate the pixels 301 to 306, thus leading to the line 310 where for example the pixel 301 is duplicated into pixels 301′ and 301″. In this method, the pixels whose color is to be replaced are horizontally adjacent, in other words, the pixels 301′ and 301″ form a pair of adjacent pixels, the next pair is 302′ and 302″, and so on up to the pair 306′ and 306″.

Line 320 shows a set of pairs of pixels (301A, 301B to 306A, 306B) having spatially alternating complementary colors and used to replace the original pixels 301 to 306. Similar to line 300, the values inside the blocks represent the colors of the pixels. Thanks to the spatial fusion of the human visual system, the spatial arrangement of the green pixel 301A and the red pixel 301B is perceived by a human observer as a brown pixel identical in perceived color to pixel 301, or more generally to the combination of pixels 301′ and 301″. A complete example is described below in relation with FIG. 3B. In other methods, for example when increasing the image resolution is not possible, other techniques are used, such as pixel skipping or pixel averaging. Examples of such methods are described below in relation with FIGS. 8A, 8B and 9.

FIG. 3B illustrates examples of replacement of a pixel by a pair of pixels according to the technique of spatially alternating complementary colors. In the figure, the array 340 represents an example of an original (i.e., before being modified) image to be displayed, here comprising three rows of four pixels each (for the sake of simplicity of the drawings). Each pixel is represented by a rectangle comprising a color value according to the colors defined in FIG. 3A. For example, the pixel 341 in the upper left corner is a brown pixel. In a first variant of such method (not illustrated), the width is doubled compared to the original image. For example, if the input image would have a size of 1920 by 1080 pixels, the modified image where the original pixels would be replaced by spatially alternating complementary color pixels would have a size of 3840 by 1080 pixels). In a second variant of such method (not illustrated), the height is doubled compared to the original image. For example, if the input image would have a size of 1920 by 1080 pixels, the modified image where the original pixels would be replaced by spatially alternating complementary color pixels would have a size of 1920 by 2160 pixels.

In a third variant of such method as illustrated in the figure, both the width and the height are doubled compared to the original image. For example, if the input image would have a size of 1920 by 1080 pixels, the modified image where the original pixels would be replaced by spatially alternating complementary color pixels would have a size of 3840 by 2160 pixels. In other words, each pixel would be replaced by a set of four pixels of two spatially alternating complementary colors. The array 350 represents an image based on the original image of array 340 and modified according to this third variant. The processor first inserts additional columns (second, fourth, sixth and eight columns) and lines (second, fourth, sixth and eight lines) to create duplicate pixels, for example to create the pixels 351 and 352 from pixel 341. Then the processor selects a first pair of adjacent pixels, for example the horizontal pair of pixels 351 and 352. From the color (301) of the first pixel 351 of the first pair of adjacent pixels, the processor determines a pair of spatially alternating complementary colors (301A, 301B) that, when combined, look identical in perceived color to the original color 301 but require less energy for its display. This process may use a table storing an association between a color and a pair of colors looking similar to it in perceived color but requiring less energy. These colors are then used to set the colors of the pair of adjacent pixels. As a result, the color of pixel 351 is set to 301A while the color of pixel 352 is set to 301B. The process is iterated over all pairs of adjacent pixels in both the horizontal and the vertical directions. The result is a modified image, whose pixels have the value of the array 350, that looks identical to the original image but requires less energy for its display when displayed on a screen. For example, the brown pixel 341 is replaced by four pixels 351, 352, 353, 354 of respective colors values 301A (green), 301B (red), 301B (red) and 301A (green). The determining of the pair of spatially alternating complementary colors corresponding to the color 301 of original pixel 341 needs to be done only once. It results on the pair (301A, 301B) that is applied onto the 4 pixels 351, 352, 353, 354 in a mosaic arrangement (i.e., changing the order between the colors of the pair for the second line) to provide a good distribution of the colors.

The first and second variants may be implemented internally in a display panel by physically doubling the number of pixels in one of the directions but without providing access to the additional pixels to the outside world. The third variant is of more general use. Indeed, the resolution of content currently available is often inferior to the capabilities of the display device. It is quite common to have a full HD content (1920×1080) displayed on a UHD-capable (3840×2160) or 4K-capable (4096×2160) device. Therefore, this technique could be considered as a simple upscaling function that while providing the additional pixels for the upscaling also provides a reduction of the energy required for displaying the upscaled image.

In the description of these methods, the first pixel of a pair of pixels is always replaced by the first color of the pair of spatially alternating complementary colors. In at least one method, an alternance is introduced between lines (respectively columns) regarding the order of selection of the pair of colors. In a first line (respectively column), the color of the first pixel of a pair of pixels is replaced by the first color of the pair of spatially alternating complementary colors and the color of the second pixel of a pair of pixels is replaced by the second color of the pair of spatially alternating complementary colors but in the second line (respectively column), the color of the first pixel of a pair of pixels is replaced by the second color of the pair of spatially alternating complementary colors and the color of the second pixel of a pair of pixels is replaced by the first color of the pair of spatially alternating complementary colors.

A second technique to minimize the energy consumption uses temporally alternating complementary colors to modify an image. This second technique is based on the principles described in relation with FIG. 2 and the principles described hereafter in FIGS. 4A and 4B.

FIG. 4A illustrates the temporal contrast sensitivity function for various adapting fields. In the spatial domain, spatial vision can be characterized by the contrast sensitivity function (CSF). To thoroughly investigate the visual system sensitivity to flicker, a Temporal Contrast Sensitivity Function (TSF) or a De Lange function can be plotted (De Lange, 1958). A TSF is a plot of how flicker varies with contrast and vice versa. In this figure, the area above the curve represents the area where no flicker is perceived by a human observer and the area below the curve represents the area where flicker is perceived. The eye appears to be most sensitive to a flicker frequency of 15 to 20 Hz at higher luminances (photopic vision). At photopic light levels, less than 1% contrast is required to detect the stimulus and the high temporal frequency cut off is close to 60 Hz. At lower light levels the maximum contrast is about 20% and the high temporal frequency cut off is approximately 15 Hz. To detect flicker of high frequencies, maximum contrast is required. Temporal resolution is not as efficient at low luminances (scotopic vision).

FIG. 4B illustrates the modulation sensitivity as a function of frequency for luminance and chromatic flicker. In this figure, the luminance levels are measured in trolands (td), unit that characterize retinal illuminance. This figure was obtained by psychovision studies, in a typical application of Heterochromatic Flicker Photometry (HFP). The participants viewed a stimulus that alternated rapidly in time between two lights of different colors; the participant then had to adjust the intensity of one of the two lights (i.e., the amplitude of the light's spectrum) to minimize the sensation of flicker produced by the alternating lights. The figure on the left side is related to luminance flicker while the figure on the right side is related to chrominance flicker. HFP has long been the standard psychophysical method for finding equiluminant colors.

While the SACC technique previously described is based on spatial fusion, another technique, hereafter named Temporal Alternating Complementary Colors (TACC) is based on temporal fusion. The principles illustrated in FIGS. 5A and 5B are used to determine a pair of colors that, when being temporally combined, are perceived by a human observer as another (single and stable) color. The technical effect used herein relies on temporal psychovisual modulation and the existence of a maximum cutoff frequency in the flicker sensitivity of human eye. Therefore, the high-level principle of TACC can be considered as adding a dimension to the image signal by temporally duplicating each pixel into two visually complementary temporally successive pixels and using this added dimension to minimize the pixel equivalent energy consumption. The two temporally successive pixels would be perceived by the user as a single pixel if the alternance between these pixels is faster than the flicker fusion frequency.

Normal flicker fusion frequency is about 50 Hz to 60 Hz and depends on retinal illumination. However, sensitivity to flicker in equiluminance situations is smaller (20 Hz to 30 Hz) than in situations where luminance varies between the two images of a pair. Then with the additional specific condition that the difference in luminance between two colors is small enough, flicker caused by the alternation of two colors is minimal. This equiluminant condition, mixed with the basic colors alternance configuration, can be used to limit the visibility of flicker.

FIG. 5A illustrates examples of transformation of colors into complementary colors according to the technique of temporally alternating complementary colors. In this figure, the line 500 shows a succession of pixels 501 to 506. The three numbers inside each block correspond to the color of the corresponding pixel, represented by RGB values expressed using an 8-bit depth. For example, the first pixel is defined by the following values for the color components of the pixel: 147 for red, 107 for green and 0 for blue. This results in a brown pixel. The colors of the other pixels are respectively medium grey for second pixel 502, navy blue for the third pixel 503, dark magenta for the fourth pixel 504, reddish brown for the fifth pixel 505, and bright green for the sixth pixel 506.

Line 510 shows a set of pairs of temporally successive pixels (501A, 501B) to (506A, 506B). These pairs of temporally successive pixels correspond to the alternating complementary colors that could be used to replace the original pixels 501 to 506. Similar to line 500, the values inside the blocks represent the colors of the temporally successive pixels. In at least one method, the temporally successive pixels are half the duration of the original pixels. In other words, a first image frequency (for instance 60 Hz) is doubled into a second image frequency (for instance 120 Hz) and an input image is decomposed into an output image pair displayed at the second image frequency. For example, the pixel 501 displayed in the input image at a frequency of 60 Hz could be replaced by the succession of the pixels 501A (green pixel) and 501B (red pixel) displayed at a global frequency of 120 Hz. The succession of the green and red pixels is perceived by a human observer as a brown pixel, thanks to the heterochromatic flicker fusion. A complete example is described below in relation with FIG. 5B.

FIG. 5B illustrates examples of replacement of a pixel by a pair of pixels according to the technique of temporally alternating complementary colors. In this method based on frame doubling, the display frequency is doubled compared to the original image frequency. For example, if the sequence of images was intended to be displayed at 50 Hz, the display frequency is doubled to display a sequence of modified images at 100 Hz, allowing to replace the original pixels by alternating complementary color pixels and thus allowing to reduce the energy consumption of the display while preserving the quality of experience.

In the figure, the line 550 represents a temporal sequence of original (i.e., before being modified) images to be displayed, here comprising three images 551, 552, and 553. These images are displayed respectively during the periods t1, t2 and t3. In the example of a 50 Hz display frequency, the length of these periods is 20 ms. For the sake of simplicity of the drawings, the illustrative images 551, 552, and 553 are composed of 2 rows of three pixels each. The pixels are represented here by numbered blocks. The number identifies the pixel color with reference to the colors introduced in FIG. 5A. For example, the first line of image 551 is composed of pixels 301, 302, and 303. Therefore, the first pixel 301 of this line is brown with RGB value of 147, 107, 0, the second pixel 302 is navy blue with RGB values of 127, 141, 141, and the third pixel 303 is dark magenta with RGB values of 82, 108, 160. In the second line, the three pixels are respectively navy blue, brown and dark magenta.

The line 560 represents a temporal sequence of the modified image to be displayed, comprising images 561, 562, 563, 564, and 565. Each of these images is displayed for half the duration compared to the line 550, in correspondence with the frequency doubling. Therefore, the initial 50 Hz display frequency for line 550 is doubled to 100 Hz in line 560 and the periods t1A, t1B, t2A, t2B and t3A are 10 ms long. Compared to line 550, a double number of images are displayed in line 560. This allows to insert intermediate images to introduce the alternating complementary color pixels, thus allowing to reduce the energy consumption when displaying the image.

For each pixel of the original image 551, a color pair is determined as described earlier in relation to FIG. 5A. This color pair is used to define a first pixel of the first color of the color pair for image 561 and a second pixel of the second color for image 562, the two pixels being displayed successively at the double frequency of the expected display of the original pixels. For example, the brown pixel 301 of image 551 is replaced by a green pixel 301A in image 561 and a red pixel 301B in image 562. These replacement red and green pixels are displayed half the time of the original brown pixel. As described previously, thanks to the human visual system color fusion, these pixels will be perceived by a human viewer as having the brown color of pixel 301, while requiring less energy for their display.

The frame doubling mechanism for pixel replacement by alternating complementary color pixels has been presented in FIG. 5B when applied to a sequence of images, in other words, a video. However, the same principle applies when displaying a single static image (e.g., text edition application on a computer screen content, configuration screen on a tablet, email application on a smartphone, static image on an advertisement screen, etc.). In this case, the FIG. 5B would be restricted to the elements related to image 551 (the single image to be displayed) and the images 561 and 562. Instead of conventionally displaying the image 551 at a given frequency, the images 561 and 562 would be displayed in alternance at a double frequency.

In other methods, for example when doubling the display frequency is not possible, other techniques are used to replace a color by a pair of colors, such as frame skipping or frame averaging. For both techniques, referring to FIG. 5B, the original video would display a second image during t1 between the image 551 and the image 552. The frame skipping method simply discards this second image so that the same principles than the frame doubling technique described above apply. The frame averaging method also discards this second image but, before that, the values of pixels of the image 551 are replaced by the average values of pixels of the image 551 and of the discarded image. After that step, the same principles than the frame doubling technique described above apply.

Both the SACC and TACC techniques are based on an association between an input color and a pair of replacement colors. This association is determined by selecting the pair of colors that satisfies two conditions: visual identity and energy reduction. The first condition is that the average color of a couple of pixels of the pair of replacement colors in a SACC or TACC modified image is equal to the level of the color of a pixel of the input color in the input image. This means that the pair of replacement pixels will be perceived by a viewer as identical to the input pixel. The second condition is that the energy needed to display the pair of replacement colors in a SACC or TACC modified image is lower than the energy needed to display the input color. In practice, this is not feasible for every input pixel. In an optimal implementation of SACC or TACC, the chosen color pair is the pair that provides the highest energy reduction. However, these techniques favor the quality of experience since the average color of a pair of replacement colors for an input color is perceptually identical to the input color. They provide an energy reduction, at a given level depending on the images. This energy reduction may be fair, sometimes small, or modest. The impact on the energy reduction is therefore done in a “best effort” mode since depending on the values of the pixels of the image, it is based on selecting, among a list of color pairs being visually identical, the pair with the lowest energy consumption.

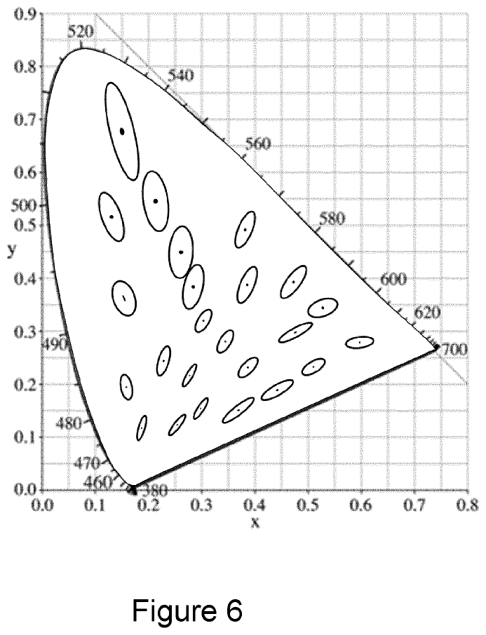

FIG. 6 illustrates the notion of indistinguishable colors represented by MacAdam ellipses for one of MacAdam's test participant. MacAdam set up an experiment in which a trained observer viewed two different colors, at a fixed luminance of about 48 cd/m². One of the colors (the “test” color) was fixed, but the other was adjustable by the observer, and the observer was asked to adjust that color until it matched the test color. This match was, of course, not perfect, since the human eye, like any other instrument, has limited accuracy. It was found by MacAdam, however, that all the matches made by the observer fell into an ellipse on the CIE 1931 chromaticity diagram. The measurements were made around 25 CIE 1931 xy color points on the chromaticity diagram, and it was found that the size and orientation of the ellipses on the diagram varied widely depending on the test color.

Therefore, a MacAdam ellipse is a region on a CIE 1931 xy chromaticity diagram which contains all colors which are indistinguishable, to the average human eye, from the color at the center of the ellipse. The contour of the ellipse therefore represents the just-noticeable differences of chromaticity. The ellipses illustrated in the figure are ten times their actual size.

A chromaticity diagram is conventionally a color printed diagram displaying the whole spectrum of color variations. In order to respect the black and white representation for patent application, the color variations are here replaced by a completely white area.

MacAdam's results confirmed earlier suspicions that color difference could be measured using a metric in a chromaticity space. A number of attempts have been made to define a color space which is not as distorted as the CIE XYZ space. The most notable of these are the CIELUV and CIELAB color spaces (1976). Although both spaces are less distorted than the CIE XYZ space, they are not completely free of distortion. This means that the MacAdam ellipses become nearly (but not exactly) circular in these spaces.

CIELAB expresses color as three values: L* for perceptual lightness and (±)a* and (±)b* for the four unique colors of human vision: red, green opposition ((±)a*), blue, yellow opposition ((±)b*). CIELAB produces a color space that is more perceptually linear than previously defined color spaces. Perceptually linear means that a change of the same amount in a color value should produce a change of about the same visual importance for another color.

In a Lab space, a metric can be defined as well as a color distance. Given two colors in CIELAB color space,

$$( {L}_{1}^{*} , {a}_{1}^{*} , {b}_{1}^{*} ) and ( {L}_{2}^{*} , {a}_{2}^{*} , {b}_{2}^{*} )$$

the color difference formula may be defined as:

$${Δ E}_{ab}^{*} = \sqrt{{( {L}_{2}^{*} - {L}_{1}^{*} )}^{2} + {( {a}_{2}^{*} - {a}_{1}^{*} )}^{2} + {( {b}_{2}^{*} - {b}_{1}^{*} )}^{2}} .$$

A color distance

$${Δ E}_{ab 1}^{*}$$

can be evaluated to correspond to a JND=1.

Although the SACC and TACC techniques ensure that the quality of experience is preserved in terms of resulting colors, they however might generate other defects, that are responsible for a decrease in quality of experience. In particular, flicker might be generated, especially by TACC, and is not always acceptable. When the two colors are too far apart in the color space, the QoE is reduced because flickering becomes too visible, and discomfort appears. Flicker is one example of the defects that may appear. Spatial defects, including loss of resolution, may also appear, in particular in SACC.

In both SACC and TACC techniques, the only criterion taken into account in the search for replacing colors is the energy gain, for example using an exhaustive minimization search, this to the detriment of the QoE (Quality of Experience) induced by defects such as flicker.

On this basis, embodiments described below aim at reducing the power consumption while maintaining a suitable target quality. This is solved by using several criteria in order to optimize the color pair search, not only in terms of power reduction gain, but also in terms of quality of experience. These embodiments propose a method for increasing the power gain while limiting the loss of quality when searching for alternate colors for power reduction by using several criteria. The proposed method includes at least one power criterion and one quality criterion. Until then, only a power criterion was used in the search for an alternating color pair replacing an original color.

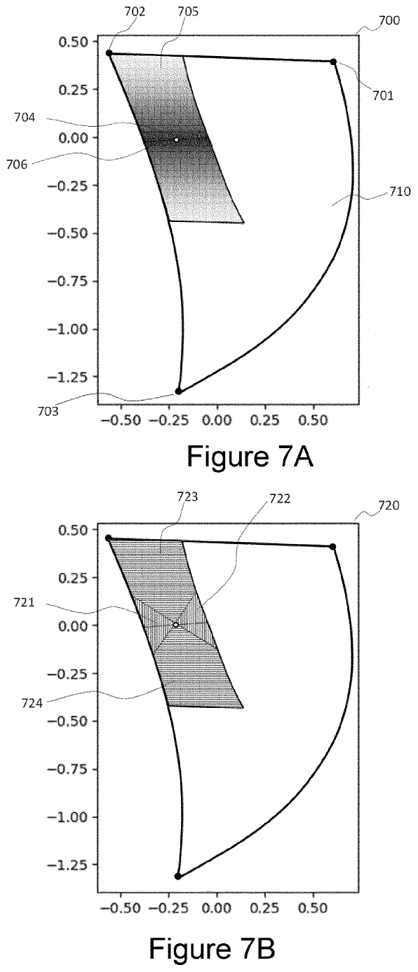

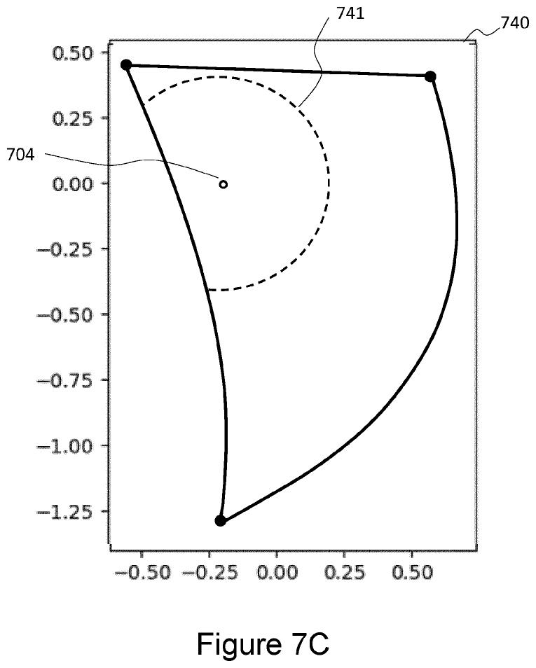

FIG. 7A illustrates the power reduction gain for a pair of colors selected according to the SACC or TACC techniques. In the diagram 700, the power reduction gain is shown within the OkLab gamut 710 and superimposed to the OkLab space (a,b) coordinates. Red, green, and blue primaries are represented respectively by the black dots 701, 702, 703. The original color for which alternate colors are searched is represented by the white dot 704. The pair of alternate colors will be searched for in the nearly rectangular region 705. Indeed, choosing a pair outside of this area would induce that one of the colors of the pair would be outside of the color space. Each value at coordinates (a,b) in this region represents the gain (possibly negative) in terms of energy realized by replacing the original color by the color in (a,b) and its symmetrical color with respect to the original color. Light colors correspond to an augmentation of power consumption while dark colors correspond to a gain in power reduction, the darker the more gain. As each color in the alternate pair plays a symmetrical role, the 705 region is also symmetrical in terms of power reduction gain. For the sake of simplicity of the drawing the area 705 depicted in the figure is an approximation. Indeed, the left and right borders should be darker than the central region since they have better gain. Obviously, no gain is realized at the pivot color's location (original color, center point in white). From this figure, alternate colors should be sought in the central region far from the light regions to maximize the power reduction gain.

In at least one embodiment, optimally, and to lessen the search complexity, these colors are only to be searched near the dotted median line 706 which maximizes the power reduction gain. On this line, the two colors of the pair are symmetrical or close to symmetrical with regard to the pivot (original) color, as seen in the SACC and TACC techniques. Finding one color of the pair gives the other color of the pair by symmetry.

FIG. 7B illustrates the areas of the color gamut with gains and losses for a pair of colors selected according to the SACC or TACC techniques. In the diagram 720, the vertically hashed areas 721 and 722 provide gains in terms of power reduction while the horizontally hashed areas 723 and 724 are worse than the original color in terms of power reduction and lead to an increase of power consumption.

FIG. 7C illustrates the flicker acceptability for a pair of colors selected according to the TACC technique. The diagram 740 shows how the quality criterion could relate to flicker. Indeed, the TACC technique may generate flicker which is not always acceptable in terms of quality of experience. When the two colors are too far apart in the color space, the QoE is reduced because flickering becomes too visible, and discomfort appears. In this figure, the closer the alternate colors are to the original color represented by the white dot 704, the less the QoE is reduced due to flicker. An acceptable region in terms of QoE may be defined (i.e., inside the dotted circle 741), beyond which the flickering is no more acceptable (i.e., outside the dotted circle 741).

FIG. 8 illustrates an example of a process for establishing the pair candidates of alternating complementary colors according to embodiments. One goal of the embodiments is to find the optimal pair of replacement colors (to be used according to the SACC or TACC techniques) that satisfies at least one criterion related to power reduction and one criterion related to quality. The process 800 is for example implemented by a processor 101 of the device 100 of FIG. 1.

The process operates in a selected color space {C}, preferably a uniform color space such as CIELab, IPT or OkLab. Uniform color spaces are built such that the same geometrical distance anywhere in the color space reflects the same amount of perceived color difference. In such color spaces, most often forward color transforms [symbol] (RGB) act on RGB to compute (CIE)XYZ and then Lab or equivalent visual coordinates (RGB to XYZ to Lab). Lab can also be computed directly from RGB (RGB to Lab). Inverse color transforms [symbol] (Lab) apply inverse operations (Lab to XYZ to RGB or directly Lab to RGB).

The process is operated on an input pixel p of color C_{IN} (within the gamut {G} in the selected color space {C}) and represented by the input color triplet R_{IN}G_{IN}B_{IN}. The example process described below uses the OkLab color space.

The process is operated also on a set of criteria. In an embodiment, the set of criteria comprises one criterion related to power reduction and one criterion related to quality of experience. Other embodiments use more than one criterion related to power reduction or more than one criterion related to quality of experience, or a plurality of criteria related to power reduction and a plurality of criteria related to quality of experience. Examples of criteria are:
Power reduction gain of the color pair:

$$\{ {𝒫}_{\frac{1}{2}} ( {R}_{A} {G}_{A} {B}_{A} ) + {𝒫}_{\frac{1}{2}} ( {R}_{B} {G}_{B} {B}_{B} ) \} . ,$$

R_{A}G_{A}B_{A} and R_{B}G_{B}B_{B} being the RGB coordinates of the respective pair colors. Since the principles are based on SACC or TACC, the gains are evaluated for half a frame period or spatial size.
Inverse of the distance between the colors of the pair

$$( \frac{1}{Δ Lab} ) .$$

This criterion is representative of the flicker's intensity.
Power reduction gain divided by the square of the inverse of the square distance between the colors of the pair

$$( \frac{𝒫}{{Δ Lab}^{2}} ) .$$

This criterion is representative of gain of energy when flicker varies.

In step 810, the processor determines the energy consumption [symbol] for the input color triplet according to a selected color power consumption model. The power consumption model is display dependent. For OLED displays, the power consumption model can follow the color model, including the RGBW case where a white LED supports the RGB LEDs for each physical pixel. A color model for a RGBW display is given by Murdoch et al. in “Perfecting the color reproduction of RGBW OLED” proc. 30th International Congress of Imaging Science. This model can be extended with adequate parameters to represent per pixel power.

In step 820, the processor determines the color point C_{IN} corresponding to the R_{IN}G_{IN}B_{IN} triplet within the gamut {G} of the color space {C}.

In step 830, the processor applies a RGB to Lab forward color transform on the R_{IN}G_{IN}B_{IN} triplet to obtain the L_{IN}a_{IN}b_{IN} coordinates in the OkLab color space:

L_{IN}a_{IN}b_{IN}= [symbol] (R_{IN}G_{IN}B_{IN})

The forward color transform is display dependent. An example of the most used color transform is sRGB to CIELab.

In step 840, the processor samples the color space {C} within the gamut {G} to determine a set of candidate colors {C_{A}} for the first color of the pair of replacement colors with regard to the selected color C_{IN}. Different criteria may be used to determine the sampling space. The coordinates L_{A}a_{A}b_{A} of candidate colors may verify certain conditions. In a first variant, aₐ=bₐ=0 so that the chosen C_{A} color is part of the grey ramp (i.e., a greyscale color). In a second variant, the coordinates L_{A}a_{A}b_{A} are chosen so that its cylindrical version L_{A}Chr_{A}h_{A} has the same luminance (L_{A}=L_{IN}) and hue (h_{A}=h_{IN}) as L_{IN}Chr_{IN}h_{IN} but maximum chroma. In other words, a saturated color is selected. L*Chr*h* is the cylindrical model based on L*a*b*. Chr* is the chroma relative saturation and h* the hue. They are defined by: Chr*=\sqrt{a*²+b*²},

$$h *= atan ( \frac{b *}{a *} ) .$$

In a third variant, L_{A}=L_{IN} so that the chosen C_{A} color has no or minimal variation in luminance compared to the input color, thus getting closer to equiluminance. In a fourth variant, L_{A}=a·L_{IN} with α∈[0.8, 1.2] so that it minimizes variations in luminance compared to the input color (quasi-equiluminance).

In at least one embodiment, the whole color gamut is explored and thus the set of candidate colors {C_{A}} is the full set of possible values. In at least another embodiment, a subset of the color gamut is chosen, for example using a smaller color resolution. In another embodiment, a number of randomly selected candidates are used. In at least one embodiment, a “maximal color distance relative to the input color” criterion is used to limit the sampling to the color space around C_{IN}.

In step 850, the process is then iterated over each color candidate C_{Ai} of coordinates L_{Ai}a_{Ai}b_{Ai} of the set of candidate colors {C_{A}}, iterating the steps 860 to 885 to build the set of candidate colors pairs {C_{AB}}.

In step 860, the processor determines, for a selected color C_{Ai} of the iteration, a second color C_{Bi} that is symmetrical to the color C_{Ai} with regard to the selected color C_{IN}. In OkLab space, the coordinates of such color are defined as:

$$\{ \begin{matrix}{L}_{{C}_{Bi}} = 2 \cdot {L}_{IN} - {L}_{{C}_{Ai}} \\ {a}_{{C}_{Bi}} = 2 \cdot {a}_{IN} - {a}_{{C}_{Ai}} \\ {b}_{{C}_{Bi}} = 2 \cdot {b}_{IN} - {b}_{{C}_{Ai}}\end{matrix}$$

where L_{IN}, a_{IN}, bL_{IN} are the Lab coordinates of the input color C_{IN}, L_{C}_{_{Ai}}, a_{C}_{_{Ai}}, b_{C}_{_{Ai}} are the Lab coordinates of the selected color C_{Ai} of the iteration over the set of candidate colors {C_{A}}, and L_{C}_{_{Bi}}, a_{C}_{_{Bi}}, b_{C}_{_{Bi}} are the Lab coordinates of the second color C_{Bi} of the pair of colors. This ensures that the combination of pixels of alternating complementary colors C_{Ai} and C_{Bi} will look identical to a pixel of color C_{IN} when using the SACC or TACC techniques.

In step 865, the processor verifies that the color C_{Bi} is comprised in the gamut {G} of the color space {C}. Indeed, if the color is out of the gamut range, it cannot be displayed so that the combination of colors C_{Ai} and C_{Bi} will not be perceptually the same as a color C_{IN}. If the color is out of the gamut, the iteration stops for the selected value of C_{Ai} since it does not lead to a correct pair of colors for the spatially or temporally successive pixels. In this case, the process starts again the iteration of the loop 850 with step 860 for the next value of C_{Ai} if any remains in the set.

In step 870, the processor determines the corresponding triplets R_{Ai}G_{Ai}B_{Ai} and R_{Bi}G_{Bi}B_{Bi} for the pair of colors C_{Ai} and C_{Bi} by applying the inverse transform:

R_{Ai}G_{Ai}B_{Ai}=I [symbol] (L_{Ai}a_{Ai}b_{Ai})

R_{Bi}G_{Bi}B_{Bi}=I [symbol] (L_{Bi}a_{Bi}b_{Bi})

In step 875, the processor determines the energy consumption P_{AiBi} of the combination of the pair of colors C_{Ai}, C_{Bi}. Since the power consumption model of the display device is not necessarily known, the energy consumption for displaying a color can simply be approximated by the sum of its RGB values to the power gamma. In embodiments where the pair of colors C_{Ai} and C_{Bi} are applied to pixels half the size (SACC) or duration (TACC) than the pixel of color C_{IN}, this is evaluated as:

$${𝒫}_{AiBi} = \frac{1}{2} 𝒫 ( {R}_{Ai} {G}_{Ai} {B}_{Ai} ) + \frac{1}{2} 𝒫 ( {R}_{Bi} {G}_{Bi} {B}_{Bi} )$$

In step 880, the processor verifies that [symbol] < [symbol] . Indeed, a candidate pair of colors for the temporally successive pixels is only considered when it brings energy reduction. If it is not the case, then the candidate pair is discarded, and the process starts again the iteration of the loop 850 with step 860 for the next value of C_{Aij} if any remains in the set. The test can also be formulated as [symbol] + [symbol] <2· [symbol] with [symbol] , [symbol] , [symbol] respectively representing the energy of a pixel of color C_{Ai}, C_{Bi}, C_{IN}. In other words, a candidate pair of alternating complementary colors is considered when the sum of the energies of the pair of alternating complementary colors is lower than twice the energy of the input color. When this test is verified, in step 885, the processor adds the candidate pair C_{Ai}, C_{Bi} to the set of candidate pairs {C_{AB}}.

In step 890, the processor selects one of the candidate pairs of the set of candidate pairs {C_{AB}} as the pair of colors to replace the color C_{IN}. The step is based on an evaluation of the set of criteria that have been defined for the process and the combination of multiple criteria for the election of the candidate as described in the examples below. This evaluation is done for all candidate pairs of the set of candidate pairs {C_{AB}}.

In an example embodiment where the set of criteria comprises one criterion related to power reduction (hereafter named Power) and one criterion related to quality of experience (hereafter named Quality), the set of criteria is {Power, Quality}.

In an example embodiment, the set of criteria comprises one criterion combining power reduction and quality of experience.

The process identifies the position of one optimum in the set of candidate pairs which is a Pareto optimum xₘₐₓ for the color pairs. If the criteria are {Power, Quality}, for the power reduction gain and the quality respectively, a first example of applying both criteria can be to find the maximum power reduction for a minimal quality level (i.e., a given maximum quality loss δ):

$${x}_{max} = {argmax}_{Quality > δ} \{ Power \}$$

A second example would identify the maximum of gain with a ratio

$$\frac{Quality}{Gain}$$

greater than a threshold α, where parameters δ and α are determined by the user or the system:

$${x}_{max} = {argmax}_{Quality > α \cdot Gain} \{ Power \}$$

A third example would identify the maximum of the product of gain and quality:

xₘₐₓ=argmax{Power·Quality}

In a fourth example, the two chosen criteria are:

$${Crit}_{1} ( {C}_{A} , {C}_{B} ) = \frac{2 \cdot Power ( {C}_{IN} ) - Power ( {C}_{A} ) - Power ( {C}_{B} )}{2 \cdot Power ( {C}_{IN} )}$$

$${Crit}_{2} ( {C}_{A} , {C}_{B} ) = \frac{2 \cdot Power ( {C}_{IN} ) - Power ( {C}_{A} ) - Power ( {C}_{B} )}{2 \cdot Power ( {C}_{IN} ) \cdot Δ ELab {( {C}_{A} , {C}_{B} )}^{2}}$$

The first criterion Crit₁ measures the power reduction gain while the second criterion Crit₂ is a measure of quality and power. Indeed, the flicker effect is proportional to ΔELab(C_{A}, C_{B})² so maximizing

$$\frac{1}{Δ ELab {( {C}_{A} , {C}_{B} )}^{2}}$$

is equivalent to minimizing the flicker and multiplying this value by the power reduction gain allows to group together a measure of power reduction gain and quality. With these criteria, the input color C_{IN} is then replaced by the color pair C_{A}, C_{B} such that:

$${C}_{A} , {C}_{B} = {argmax}_{{Crit}_{2} = max ( {Crit}_{2} )} \{ {Crit}_{1} \}$$

Crit₂ corresponds to one implementation of the above invention as this criterion is related to both power reduction gain and quality. Its optimization will jointly optimize the power reduction gain and the quality, in the proposed implementation.

The condition Crit₂=max (Cᵣᵢₜ₂) is verified only for a certain line that passes through C_{IN} as shown in FIG. 7A. Instead of performing the evaluation of Crit₂ for the set of candidates, it is then sufficient to choose the point with the highest power reduction gain on this line to obtain the optimum, which further makes it a fast implementation, compared to conventional implementation of the SACC and TACC techniques.

In at least one embodiment, the step 880 is performed after the step 890.

Unlike an implementation without quality constraints, enabling quality reduction may allow significant power reduction gains.

Relative to other methods that aim to reduce energy consumption, the proposed method controls the quality loss during the transformation. QoE is therefore controlled, and power gains are still significant (around 3-4%).

Another problem solved by the above implementation is related to the processing time needed when searching for adequate alternate colors, that comes with the increase of search space from 3 to 6 dimensions. Indeed, this increase of search space dimension also goes with an increase of complexity in the process to explore the search space, to find the best alternating colors. The proposed implementation reduces the time needed to find the optimum as the search is conducted along a simple line.

In at least one embodiment, the correspondence between a color C_{IN} and a color pair replacement as established using the process 800 is stored in a correspondence table so that the subsequent color replacement can be done very efficiently. Providing the input color to the correspondence table would allow to get immediately the corresponding color pair without having to perform again the whole process 800.

FIG. 9 illustrates an example of a process for reducing the energy consumption for a pixel of an image using alternating complementary colors according to embodiments. The process 900 is for example implemented by a processor 101 of the device 100 of FIG. 1.

In step 910, the processor obtains the visual content, or a part of the visual content, for example an image of a sequence of images comprising a set of pixels.

In step 930, the image modification algorithm is applied to the visual content. The step 930 is iterated over a plurality of pixels of the visual content (for example over all pixels). In step 932, the processor obtains a pixel p of color C_{IN}. In step 934, the processor determines a pair of spatially or temporally alternating complementary colors C_{A}, C_{B} with reduced energy consumption according to embodiments described above, for example the process 800 of FIG. 8. In at least an embodiment, the step 934 is based on a correspondence table generated by the process 1000 of FIG. 10. Such a correspondence table stores an association between an input color and pair of replacement colors. In step 936, the processor replaces pixel p by a pair of spatially or temporally half-pixels p_{A} and p_{B} of respective colors C_{A} and C_{B} as determined in step 934, either using the spatially alternating complementary color technique or the temporally alternating complementary color technique described above.

In step 950, the modified visual content is provided, for example displayed on a screen or transmitted on a communication network.

In at least one embodiment, only a subset of the whole image is processed instead of processing the whole image. For that purpose, an additional step is added before the step 932 to check that the pixel p spatially belongs to a subset of the image that is to be processed, for example belonging to a region in the image having the highest ability to mask artefacts. Such a region or mask can be given by for example a spatio-temporal just noticeable difference (JND) map, a motion field, a saliency map, etc. If the pixel p does not belong to this region or mask, no color pair replacement will be considered for this pixel and thus the process steps 932 to 936 will not be performed for this pixel. Other considerations could trigger the exclusion of subsets of the pixels, for example the overlay of graphics over the image.

FIG. 10 illustrates an example of a process for generating a correspondence table for alternating complementary colors according to embodiments. The process 1000 is for example implemented by a processor 101 of the device 100 of FIG. 1. The step 1010 may be iterated multiple times. In at least one embodiment, the iterations are done over all possible colors in the color gamut. In at least one other embodiment, the iterations are done over a sub-sampled color space only. In at least one other embodiment, the iterations are done over all unique colors of an image or regions of an image or a predetermined set of images. Other embodiments may use other subset of colors. Each iteration comprises the steps 1011, 1012 and 1013. In step 1011, the processor obtains an input color C_{IN}. In step 1012, a pair of alternating complementary colors C_{A} and C_{B} corresponding to the input color is determined, for example using the process 800 of FIG. 8 that selects the pair providing the best results according to a set of criteria, as discussed above with reference to step 890 of FIG. 8. In step 1013, the association between the input color C_{IN} and the selected pair of alternating complementary colors C_{A} and C_{B} is stored in a correspondence table. At the end of process 1000, the correspondence table comprises a set of associations between input colors and pairs of alternating complementary colors. This table may be used either for methods based on SACC or on TACC.

FIG. 11 illustrates two examples of deployment for the alternating complementary color process according to embodiments. In at least one embodiment, the principles described above are implemented in a display device 1110 which is the one described in FIG. 1. In this case, the processor 101 of the device 1110 is configured to obtain an input image or video 1100 and displays it on the display unit 103 of FIG. 1 after being processed by the SACC or TACC process according to embodiments as described above. In other words, the processor 101 of the device 1110 is configured to obtain an input image or video 1100 and use the ACC techniques 1111 (either SACC or TACC) to determine a modified image or video to be displayed using spatially or temporally alternating complementary colors obtained by using a correspondence table 1112 that results into an image providing reduced energy consumption of the display device when compared to displaying the original input image. The correspondence table may be obtained from a data provider through a communication network and/or from an internal memory of the device. The image or video 1100 may be obtained from a data provider through a communication network, from an internal memory of the device, stored for example after being captured by an input unit. Typical examples of devices 1110 are smartphones, tablets, laptops, external monitors, head-mounted displays, television sets, video projectors, computer screens, vehicles (e.g., control and/or entertainment systems for cars, planes, boats, etc.), advertisement display panels, medical monitors, etc. However, any device or composition of devices that provides similar functionalities can be used as display device 1110 while still conforming with the principles of the disclosure.

In at least one embodiment, the principles described above are implemented in a device 1120 that does not include a display unit but prepares data for display so that another device 1130, such as a screen, can perform the display. In this case, the processor of the device implements the SACC or TACC process 1121 based on a correspondence table 1122 described above and generates anew image or video 1140 that is perceptually similar to the original video but will require less energy when being displayed. This modified video is then provided to a display device 1130 for being presented to a human viewer. Example of such devices 1120 are set top boxes, media players, desktop computers, encoders, decoders, servers, computing grids, cloud computers, etc.

Light production in display devices, including mobile phones and televisions, is costly. Reduction of the amount of light produced is desirable, as this helps to reduce the amount of energy necessary to operate the display. The advantage of this is two-fold: less pressure on the climate, and longer battery life in mobile devices. Relative to other methods that aim to reduce energy consumption for the same reasons, the proposed method guarantees that the light emitted by each pixel is produced with a combination of sub-pixels minimizing energy consumption in average. This minimized energy is also increased/optimized thanks to the acceptance of a decrease of the quality of experience. Determining the pair of colors is faster than with conventional SACC or TACC implementations, thanks to the use of the plurality of criteria.

Although parts of the description refer to images, the embodiments are not restricted to images and apply to any type of visual media content such as conventional (2D) videos, stereoscopic (3D) images or videos, 3600 immersive images or video, based on the same principles as described above but iterated temporally and/or spatially.

In general, one or more other examples of embodiments can also provide a computer readable storage medium, e.g., a non-volatile computer readable storage medium, having stored thereon instructions for encoding or decoding picture information such as video data according to the methods or the apparatus described herein. One or more embodiments can also provide a computer readable storage medium having stored thereon a bitstream generated according to methods or apparatus described herein. One or more embodiments can also provide methods and apparatus for transmitting or receiving a bitstream or signal generated according to methods or apparatus described herein.

Many of the examples of embodiments described herein are described with specificity and, at least to show the individual characteristics, are often described in a manner that may sound limiting. However, this is for purposes of clarity in description, and does not limit the application or scope of those aspects. Indeed, all the different aspects can be combined and interchanged to provide further aspects. Moreover, the embodiments, features, etc. can be combined and interchanged with others described in earlier filings as well.

Various implementations involve decoding. “Decoding”, as used in this application, can encompass all or part of the processes performed, for example, on a received encoded sequence to produce a final output suitable for display. In various embodiments, such processes include one or more of the processes typically performed by a decoder, for example, entropy decoding, inverse quantization, inverse transformation, and differential decoding. In various embodiments, such processes also, or alternatively, include processes performed by a decoder of various implementations described in this application.

As further examples, in one embodiment “decoding” refers only to entropy decoding, in another embodiment “decoding” refers only to differential decoding, and in another embodiment “decoding” refers to a combination of entropy decoding and differential decoding. Whether the phrase “decoding process” is intended to refer specifically to a subset of operations or generally to the broader decoding process will be clear based on the context of the specific descriptions and is believed to be well understood by those skilled in the art.

Various implementations involve encoding. In an analogous way to the above discussion about “decoding”, “encoding” as used in this application can encompass all or part of the processes performed, for example, on an input video sequence in order to produce an encoded bitstream. In various embodiments, such processes include one or more of the processes typically performed by an encoder, for example, partitioning, differential encoding, transformation, quantization, and entropy encoding.

As further examples, in one embodiment “encoding” refers only to entropy encoding, in another embodiment “encoding” refers only to differential encoding, and in another embodiment “encoding” refers to a combination of differential encoding and entropy encoding. Whether the phrase “encoding process” is intended to refer specifically to a subset of operations or generally to the broader encoding process will be clear based on the context of the specific descriptions and is believed to be well understood by those skilled in the art.

Note that the syntax elements as used herein are descriptive terms. As such, they do not preclude the use of other syntax element names.

When a figure is presented as a flow diagram, it also provides a block diagram of a corresponding apparatus. Similarly, when a figure is presented as a block diagram, it also provides a flow diagram of a corresponding method/process.

In general, the examples of embodiments, implementations, features, etc., described herein can be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or program). An apparatus can be implemented in, for example, appropriate hardware, software, and firmware. One or more examples of methods can be implemented in, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users. Also, use of the term “processor” herein is intended to broadly encompass various configurations of one processor or more than one processor.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this application are not necessarily all referring to the same embodiment.

Additionally, this application may refer to “determining” various pieces of information. Determining the information can include one or more of, for example, estimating the information, calculating the information, predicting the information, or retrieving the information from memory.

Further, this application may refer to “accessing” various pieces of information. Accessing the information can include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information. Receiving is, as with “accessing”, intended to be a broad term. Receiving the information can include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

As will be evident to one of ordinary skill in the art, implementations can produce a variety of signals formatted to carry information that can be, for example, stored or transmitted. The information can include, for example, instructions for performing a method, or data produced by one of the described implementations. For example, a signal can be formatted to carry the bitstream of a described embodiment. Such a signal can be formatted, for example, as an electromagnetic wave (for example, using a radio frequency portion of spectrum) or as a baseband signal. The formatting can include, for example, encoding a data stream and modulating a carrier with the encoded data stream. The information that the signal carries can be, for example, analog or digital information. The signal can be transmitted over a variety of different wired or wireless links, as is known. The signal can be stored on a processor-readable medium.

Various embodiments are described herein. Features of these embodiments can be provided alone or in any combination, across various claim categories and types.

1. A method comprising, for an input color (CIN) in an image, determining a pair of symmetrical colors with regard to the input color in a lab color space, the pair being a pair of alternating complementary colors (CA, CB),
wherein the determination comprises selecting the pair (CA, CB) by evaluating at least one quality criterion and at least one power reduction criterion or based on a criterion combining quality and power reduction, and wherein the selected pair (CA, CB) satisfies the following conditions:
a symmetrical relationship exists between the colors (CA, CB) of the pair and the input color (CIN) in the lab color space;
an average color of the pair of spatially or temporally alternating complementary colors, when displayed as spatially or temporally alternating, is perceptually identical to the input color, and
a sum of energies consumed by displaying the colors of the pair of spatially or temporally alternating complementary colors, when displayed as spatially or temporally alternating, is determined to be lower than twice an energy consumed by displaying the input color.

2. The method of claim 1, further comprising selecting a color value for a first color of the pair of spatially alternating complementary colors according to a selection criterion and determining a second color of the pair of spatially alternating complementary colors based on the selected first color value and on the input color.

3. The method of claim 2, wherein the selection criterion is a maximal color distance of the first color of the pair of spatially alternating complementary colors relative to the input color.

4. The method of claim 2, wherein the selection criterion is that the color of the first color of the pair of spatially alternating complementary colors is a saturated color.

5. The method of claim 2, wherein the selection criterion is that the color of the first color of the pair of spatially alternating complementary colors is a greyscale color.

6. The method of claim 2, wherein the selection criterion is that the color of the first color of the pair of spatially alternating complementary colors has the same luminance as the input color.

7. The method of claim 2, further comprising iterating the method for a plurality of input colors comprising colors of all pixels of an input image or of a subset of all pixels of the input image.

8. The method of claim 2, further comprising iterating the method for a plurality of input colors comprising all possible color values of the lab color space or a subset of all possible color values of the lab color space.

9. The method of claim 7, further comprising storing an association between an input color and a pair of spatially alternating complementary colors corresponding to the input color.

10. The method of claim 9, wherein the association is stored in a correspondence table using input colors as indices.

11. A method comprising:
obtaining a visual content;
iterating over pixels of the visual content and, for an iterated pixel:
obtaining color of the pixel;
determining a pair of colors according to the method of claim 1;
replacing the pixel by a pair of spatially or temporally half-pixels, the first half-pixel being assigned a first color of the pair of colors and the second half-pixel being assigned a second color of the pair of colors; and
providing the modified visual content.

12-13. (canceled)

14. A non-transitory computer readable medium storing executable program instructions to cause a computer executing the instructions to perform a method according to claim 1.

15. The method of claim 8, further comprising storing an association between an input color and a pair of spatially alternating complementary colors corresponding to the input color.

16. The method of claim 15, wherein the association is stored in a correspondence table using input colors as indices.

17. The method according to claim 1, wherein the selection of the pair (CA, CB) is performed by identifying a Pareto optimum based on the evaluated at least one quality criterion and at least one power reduction criterion or the criterion combining quality and power reduction.

18. An apparatus comprising a processor configured to, for an input color (CIN) in an image, determine a pair of symmetrical colors with regard to the input color in a lab color space, the pair being a pair of alternating complementary colors (CA, CB),
wherein the determination comprises selecting the pair (CA, CB) by evaluating at least one quality criterion and at least one power reduction criterion or based on a criterion combining quality and power reduction, and wherein the selected pair (CA, CB) satisfies the following conditions:
a symmetrical relationship exists between the colors (CA, CB) of the pair and the input color (CIN) in the lab color space;
an average color of the pair of spatially or temporally alternating complementary colors, when displayed as spatially or temporally alternating, is perceptually identical to the input color; and
a sum of energies consumed by displaying the colors of the pair of spatially or temporally alternating complementary colors, when displayed as spatially or temporally alternating, is determined to be lower than twice an energy consumed by displaying the input color.

19. The apparatus of claim 18, wherein the processor is configured to select a color value for a first color of the pair of spatially alternating complementary colors according to a selection criterion and to determine a second color of the pair of spatially alternating complementary colors based on the selected first color value and on the input color.

20. The apparatus of claim 18, wherein the selection of the pair (CA, CB) is performed by identifying a Pareto optimum based on the evaluated at least one quality criterion and at least one power reduction criterion or the criterion combining quality and power reduction.

21. The apparatus of claim 18, wherein the processor is configured to iterate the determining of the pair of alternating complementary colors over a plurality of input colors comprising all possible color values of the lab color space or a subset of all possible color values of the lab color space or colors of all pixels of an input image or of a subset of all pixels of the input image.

22. The apparatus of claim 21, wherein the processor is configured to store an association between an input color and a pair of spatially alternating complementary colors corresponding to the input color, and wherein the association is stored in a correspondence table using input colors as indices.
